(19) United States
(12) Patent Application Publication
(10) Pub. No.: US 2005/0116461 A1
(43) Pub. Date: Jun. 2, 2005

(54) Method for manufacturing bound publications, an integrated system for producing multiple bound publications of booklets or catalogs of any page quantity and a bound publication

(76) Inventors: Robert Katz, Short Hills, NJ (US); Eli Bloomstein, Centreville, VA (US); Stanford Silverschotz, Livingston, NJ (US); James Remy, Washington Township, NJ (US)

Correspondence Address: ANDERSON, KILL & OLICK, P.C., 1251 AVENUE OF THE AMERICAS, NEW YORK,, NY, 10020-1182, US

(21) Appl. No.: 10/965,630

(22) Filed: Oct. 14, 2004

Related U.S. Application Data
(60) Provisional application No. 60/511,626, filed on Oct. 14, 2003.

(51) Int. Cl. B42D 1/00

(52) U.S. Cl. 281/21.1

(57) ABSTRACT

An integrated system and method for producing multiple bound publications of booklets or catalogs independent of the number of the number of pages wherein data is printed on a movable web under the control of a computer to automatically organize and format successive print size pages, multiple score lines are formed in a direction transverse to the web travel, adhesive is applied in narrow bands on opposite adjacent sides of the score lines except for the page designated to be the first page of a booklet, folding the web at the score lines into a stack and trimming only along one end of the stack to trim off the folds at such end.

### FIELD OF THE INVENTION

The invention relates to a method for manufacturing bound publications each consisting of multiple pages of printed matter in the form of a booklet, catalog etc., an integrated system for producing multiple bound publications of booklets or catalogs of any page quantity and to a multiple page bound publication of printed matter.

### BACKGROUND OF THE INVENTION

Current practice in the printing industry in the production of quantities of multi-page booklets is to print, fold and/or crossfold individual or overlaid sheets into what is referred to in the art as “signatures”, thus providing “signatures” of folded pages containing from two to thirty-two pages or sides. These individual signatures are usually combined with others, containing different printing, to form booklets. Thereafter, the signatures are bound together by use of staples, adhesive joining compounds, and similar measures. One common method for binding signatures is to apply an adhesive and cover sheet to the ends of a stack of signatures. This method is known as perfect binding.

The current practice contains several shortcomings. First, the printing process demands quantity runs of each signature. These must be stored for later combination. This storage for later selective retrieval requires substantial storage space. Moreover, the retrieval process requires great care in selecting the proper signature sequence for combination. An incorrect sequence followed by binding could create erroneously correlated pages in a booklet. Even when correctly combined, the entire process requires segments of time for each step in the process: printing, crossfolding, storage, and combining of signatures. The collection of signatures and their storage continues until the last signature of a booklet is produced and the combining bindery can commence.

### ADVANTAGES OF THE INVENTION

This invention overcomes the need to provide signatures in the manufacture of booklets. Moreover, the present invention integrates the binding and printing operation into a single integrated system. Accordingly, booklets of any page quantity can be produced without the requirement of storage and later assembly of pre-printed material. Moreover, this invention provides for a unique binding structure for the pages of a booklet. This invention also provides a low cost method of producing booklets in that it eliminates the cost of signature inventory and storage space. This invention eliminates potential bindery errors in which incorrect signature sequences are bound.

This invention integrates the currently available continuous web digital printing capabilities and a unique in-line binding method that produces complete booklets in a single in-line process. Additionally, the booklets need not adhere to a requirement that the total page count of a booklet be a multiple of a signature page count as is the case in conventional booklet manufacture. The booklets produced as described in this invention may be precisely the page count required by the text and graphics.

### SUMMARY OF THE INVENTION

The method of the present invention for manufacturing bound publications with each consisting of multiple pages of printed matter in the form of a booklet, catalog etc. includes the steps of:

printing data on a movable web being fed in a given direction of travel past an imaging station under the control of a computer in which the data is automatically organized and formatted on successive print size pages;

forming multiple score lines of indentations and/or perforations in a direction transverse to the direction of web travel to delineate successive pages of data;

selectively applying a narrow band of adhesive on opposite adjacent sides of each or alternate score lines except for each page determined by said computer to represent the first page of a booklet or catalog;

fan folding the web at each score line into a fan folded stack of multiple pages of printed matter having opposite ends; and

trimming the stack along one end thereof to trim off all of the folds at such end so as to automatically form a bound publication of successive pages bound together on the opposite end of the stack though said adhesive.

The integrated system of the present invention for producing multiple bound publications of booklets or catalogs of any page quantity comprises:

means for transmitting data to a computer under the control of a process control center with the data organized and formatted for printing onto a web of a printable medium; means for continuously feeding said web in a given direction of travel through a printing station under the control of said computer for printing the data in batches on successive print size pages;

means for scoring said web to form multiple score lines of indentations and/or perforations in a direction transverse to the direction of web travel to delineate successive pages of data;

means for selectively applying a narrow band of an adhesive composition on opposite adjacent sides of each or alternate score lines except for each page determined by said computer to represent the first page of a booklet or catalog;

means for folding the web at each score line to form a fan folded stack of multiple pages of printed matter having opposite ends; and

means for trimming the stack along one end thereof to trim off all of the folds at such end so as to automatically form a bound publication of successive pages bound together on the opposite end of the stack though said adhesive.

In addition, this invention covers a bound publication consisting of multiple pages of printed matter having successive pages of the publication bound together without overlapping edges solely by an adhesive material along a surface forming the vertical periphery of the pages on only one side thereof and with no adhesive present on the first page of the publication.

### DESCRIPTION OF PREFERRED EMBODIMENTS

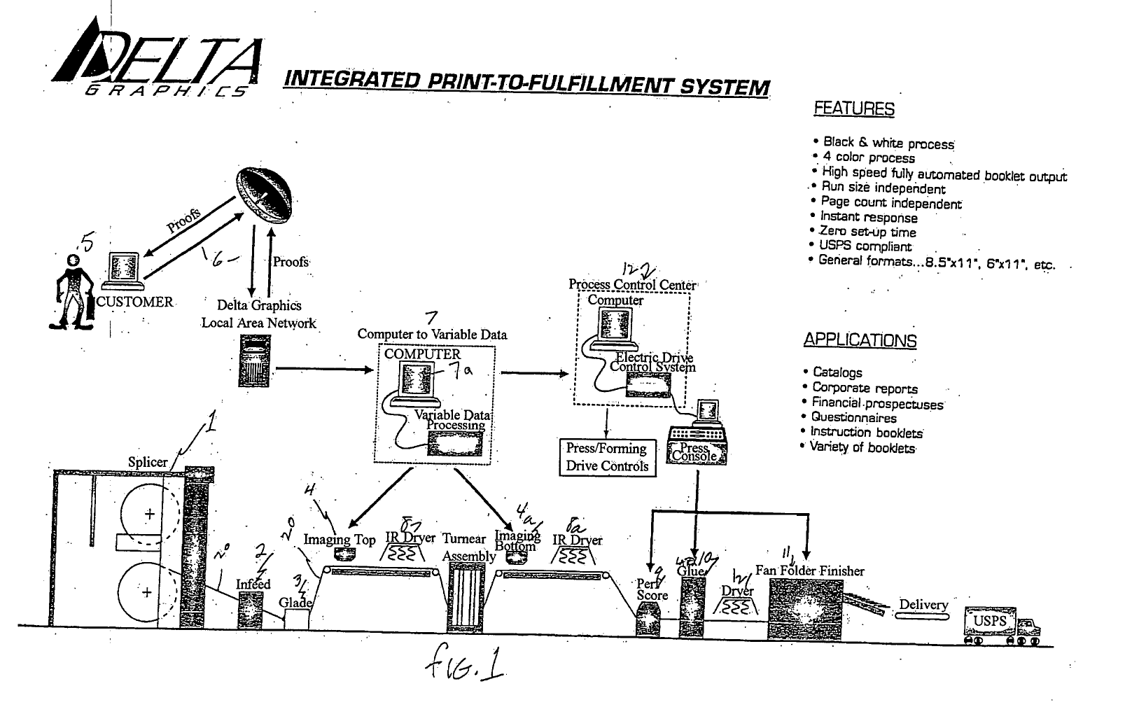

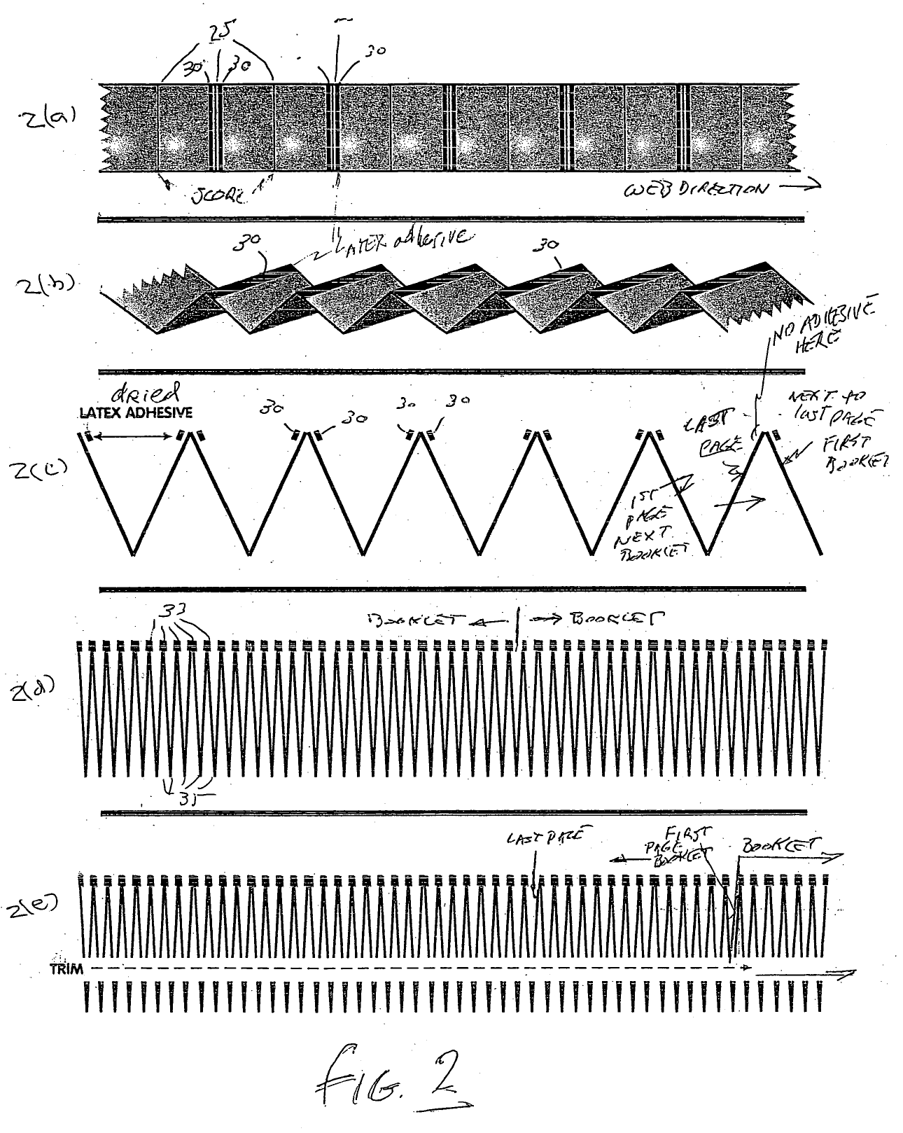

The description should be read in conjunction with the attached drawings inclusive of FIGS. 1 and FIGS. 2a-2e respectively.

FIG. 1 is a schematic block diagram, partly diagrammatic, of the integrated printing and binding system of the present invention and

FIGS. 2a-2e illustrate the sequence of the integrated binding and booklet forming operations in the process of the present invention.

The process utilizes an automated “in-line” procedure beginning with rolls of paper fed by an automatic splicer 1 which, of itself, is a conventional machine. The splicer 1 feeds an uninterrupted paper supply in the form of a continuous web of printing paper to the rest of the in-line printing and binding system shown in FIG. 1. An in feed controller 2 and an automatic lateral guide 3 regulate the feed of the printable web of paper 20 to a digitally controlled first imaging printing device 4. The imaging device may be of the ink-jet type or of the xerographic type. The ink-jet type is preferred because of its higher speed capability. Examples of known preferred ink-jet imaging equipment include the Scitex VersaMark from Scitex Digital Printing, Inc., Dayton, Ohio or the Xeikon 50D Digital press.

Variable digital printing (“VDP”) of data or fixed plate printing of data originates from a customer 5. The data may be transmitted electronically in various forms, analog or digital, proofed and corrected 6 and then processed into variable data 7 by a computer 7a as is well known to those skilled in the art. Variable data processing of such data or fixed plate processing is practiced in accordance with the protocol of the particular imaging system being used. This invention is applicable to both types of data processing and the operation of printing data on the web of paper 20 in a single pass as the web 20 is fed through the imaging device (printer) 4 is conducted under the control of the process control center 12 and is, of itself, conventional. Accordingly, the organization and presentation of batches of data on the web 20 to formulate sequential pages of data may be readily performed by those skilled in the art under the control of the computer 7a with the page count for each booklet to be determined in advance by the text and graphics.

The imaged printing on one side of the web 20 is dried in an infra-red drier station 8 with the web of paper 20 then turned over by a turn bar apparatus 9 to allow imaging on the reverse side of the web paper 20 before subsequent drying in a second infra-red drying station 8A.

Following imaging on both sides of the web 20 and drying, the web 20 is passed through a scoring machine 9 to selectively perforate and/or score the web 20 in a direction transverse to the direction of web travel so as to form a multiplicity of perforated scores 25 along the continuous web 20 as shown in FIG. 2a. Each score 25 may be represented a series of indentations or perforated dots or by one or more elongated scores aligned transverse to the longitudinal axis of the continuous web 20. An adhesive layer preferably of a latex adhesive composition is applied to the web 20 at the glue station 10 as shown in FIG. 1 to form an adhesive band 30 disposed laterally on opposite sides of alternating score lines 25 except for the page of text and/or graphics which is determined to be the first page to be folded, i.e., the starting page of each booklet upon which adhesive is not applied. The band 30 of adhesive latex should be as narrow as practical e.g. 0.250 inches and may represent a continuous or discontinuous band such as in the form of a series of dots of adhesive 30. As shown the latex adhesive 30 is omitted from the first page to be folded.

The scoring and/or perforating is necessary to implement folding using the downstream automatic in-line folding equipment 11. The latex adhesive is applied as shown in FIG. 2 and dried 12 prior to entry into the folding machine 11. A suitable folding machine is the G. Fordyce Co. Variable size folder VS Series type. The folding machine folds the web at the score lines to form a fan folded stack having opposite folded ends 33 and 35 respectively. For simplicity of description, the folded ends 33 will be referred to as the foot folds and the ends 35 as the head folds.

The latex adhesive may be of the type supplied by the Craig Adhesive Co. as Craigstik 3991 PLV. This and similar products have the characteristic that once dried, they lose adhesive characteristics except to surfaces coated with the same dried product.

Accordingly, as folding takes place, a simultaneous binding occurs at the latex coated folded ends 33. Thus, after trimming, the output of the folder is a series of pages adhesively bound on only one edge of the folded stack. By trimming off the head folded ends 35 of the stack along the trim line as shown in FIG. 2e, one continuous booklet is formed. It should be understood that the adhesive could be applied adjacent each score line 25 on opposite sides thereof except for the last page of the booklet without skipping alternate score lines 25 since the trimming operation removes the folded ends 35. However this would be wasteful of latex adhesive and prevent the discarded ends from being recycled. The length of paper at the head folded ends 35 which are removed in the trimming operation should be as small as is practical and will represent a fixed distance under the operation of the process control center 12 such that the remaining pages of the booklet are of standard paper length.

By skipping adhesive on the last page of a booklet permits each booklet to be automatically separated from each other thereby automatically producing multiple booklets.

The selective application and non-application of latex adhesive at the glue station 10 of FIG. 1 may be accomplished by cam action on the gluer with an electronic signal generated at the press control center 12 based on data derived from the initial variable data processing.

Alternatively, a cue mark may be printed on the web at the imaging station and read by photoelectric optics at the gluing station to deactivate the gluing at a particular fold line on the web.

It is noted that this process creates a unique and novel binding structure in that the pages are adhered together on their surface at the near periphery without overlapping edges. This is distinctly unlike so called “perfect binding” where adhesives are applied to the edges of paper at the bound end of a book or booklet.

1. A method for manufacturing bound publications each consisting of multiple pages of printed matter in the form of a booklet, catalog etc. comprising the steps of:
printing data on a movable web being fed in a given direction of travel past an imaging station under the control of a computer in which the data is automatically organized and formatted on successive print size pages;
forming multiple score lines of indentations and/or perforations in a direction transverse to the direction of web travel to delineate successive pages of data;
selectively applying a narrow band of adhesive on opposite adjacent sides of each or alternate score lines except for each page determined by said computer to represent the first page of a booklet or catalog;
fan folding the web at each score line into a fan folded stack of multiple pages of printed matter having opposite ends; and
trimming the stack along one end thereof to trim off all of the folds at such end so as to automatically form a bound publication of successive pages bound together on the opposite end of the stack though said adhesive.

2. An integrated system for producing multiple bound publications of booklets or catalogs of any page quantity comprising:
means for transmitting data to a computer under the control of a process control center to be organized and formatted for printing onto a web of a printable medium;
means for continuously feeding said web in a given direction of travel through a printing station under the control of said computer for printing the data in batches on successive print size pages;
means for scoring said web to form multiple score lines of indentations and/or perforations in a direction transverse to the direction of web travel to delineate successive pages of data;
means for selectively applying a narrow band of an adhesive composition on opposite adjacent sides of each or alternate score lines except for each page determined by said computer to represent the first page of a booklet or catalog;
means for folding the web at each score line to form a fan folded stack of multiple pages of printed matter having opposite ends; and
means for trimming the stack along one end thereof to trim off all of the folds at such end so as to automatically form a bound publication of successive pages bound together on the opposite end of the stack though said adhesive.

3. A bound publication consisting of multiple pages of printed matter having successive pages of the publication bound together without overlapping edges solely by an adhesive material along a surface forming the vertical periphery of the pages on only one side thereof and with no adhesive present on the first page of the publication.
